(19) United States
(12) Patent Application Publication
(10) Pub. No.: US 2013/0223921 A1
(43) Pub. Date: Aug. 29, 2013

(54) CONNECTING ELEMENT FOR A FRICTION WELD CONNECTION FOR CONNECTING AT LEAST TWO PLATE-LIKE COMPONENTS

(71) Applicant: Eberhard Christ, Tambach-Dietharz (DE)

(72) Inventor: Eberhard Christ, Tambach-Dietharz (DE)

(73) Assignee: EJOT GMBH & CO. KG, Bad Laasphe (DE)

(21) Appl. No.: 13/638,446

(22) PCT Filed: Mar. 25, 2011
(86) PCT No.: PCT/EP2011/054620

§ 371 Date: Dec. 4, 2012

(30) Foreign Application Priority Data
Mar. 29, 2010 (DE) 10 2010 013 229.2

(51) Int. Cl. B23K 20/12

(52) U.S. Cl. CPC B23K 20/12
USPC 403/270

(57) ABSTRACT

The invention relates to a connecting element (1) for a friction weld connection for connecting at least two plate-like components (8, 9), having a centering part (4) for centering and guiding the connecting element (1) subjected to rotation and pressure during penetration of the upper component or components (8) by a mandrel (2), the length thereof being adapted to the thickness of the upper component or components (8). The centering part protrudes as a pin (4, 13 16 18) from a substantially flat cross-sectional area of the mandrel transitioning into the friction weld connection and is formed so short and thin relative to the length of the mandrel that, after penetrating the upper component or components, the material of said centering part softens and the centering part thus practically completely transitions into the friction weld connection.

The invention relates to a connecting element for a friction-welded connection for connecting at least two plate-like components, having a centering part for centering and guiding the connecting element subjected to rotation and pressure during penetration of the top component(s) by a mandrel whose length has been adapted to the thickness of the top component(s).

The process of friction-welding has already been used for permanently connecting two plate-like components, as is disclosed for example in U.S. Pat. No. 3,477,115. This printed document describes how a connecting element is placed onto two metal plates that lie on top of each other and is then made to rotate and driven through the top component. In this process, the frictional heat generated in the region of a mandrel that is part of the connecting element results in the top component being heated to such an extent that it will melt in the region of the mandrel, thus allowing the mandrel to penetrate as far as the region of the bottom component where it will remain once the material of the top and bottom components has solidified again and the connecting element has stopped rotating. A collar mounted on said connecting element is then positioned on said top component, thus ensuring that the two components will remain firmly connected to each other.

DE 10 2009 006 775 A1 furthermore discloses a connecting element for connecting two adjacent work-pieces, i.e. two sheet-metal parts as specified in the embodiment. As a characteristic feature, the connecting or joining element exhibits a round protrusion which is designed in the form of a rounded mandrel and is to improve the joining of the two workpieces. However, no particular reasons are given in the printed publication why this design was chosen.

Already with these designs for connecting two plate-like components it was found that the connecting elements can be made to taper in the region of their mandrels, thus giving this relatively sharply tapering portion a centering function (see DE 10 2006 013 529 A1). This is a relatively complex design that requires a sophisticated manufacturing process. It is thus unsuitable for inexpensive mass production using press technology and has apparently not caught on for this reason.

It is the object of the invention to provide a connecting element which can be produced with little manufacturing effort and is particularly well suited for connecting at least two plate-like components so that this connecting element can be used to obtain—in a continuous subsequent process—a friction-welded connection of at least two plate-like components in a continuous operation. The design of the connecting element on the one hand ensures precise guiding to the friction-welded connection and on the other hand safeguards a secure connection of the two plates.

The connecting element of the invention is characterized in that the centering part protrudes from a substantially flat cross-sectional surface of the mandrel which transitions into the friction-welded connection and is formed so short and thin relative to the length of the mandrel that, after penetrating the top component(s), the material of said centering part softens and the centering part thus practically completely transitions into the friction-welded connection.

Owing to its short and thin design, the connecting element having the mandrel for accomplishing the friction-welded connection and a centering part in the form of a pin can be manufactured in a particularly inexpensive way. From the very beginning of the connection process, the pin-shaped centering part ensures secure guiding of the elements involved, thus allowing the connecting element to act on the intended connection site in a focused manner. The short and thin centering part prevents the mandrel from drifting from the respective application position. Consequently, each connecting process can be performed by the pin-shaped centering part in a focused way and the frictional energy applied is focused exclusively on the respective position of the penetrating connecting element.

The connecting element can also be designed to have a recess surrounding the centering part which serves to accommodate the softened material of said centering part once the centering part has reached the bottom component. This may have a favorable effect on the friction-welding process as it prevents any softened material of the centering pin from ending up between the cross-sectional surface of the mandrel and the bottom plate.

The centering part may be designed as a cylindrical pin. However, it is also possible to make the pin conical in shape. Moreover, the pin may be provided with a central recess, thus making it similar in shape to a hollow cylinder. This reduces the volume of the pin, improves the guiding function of the pin and also facilitates its manufacture.

Illustrative embodiments of the invention are presented in the drawings, in which:

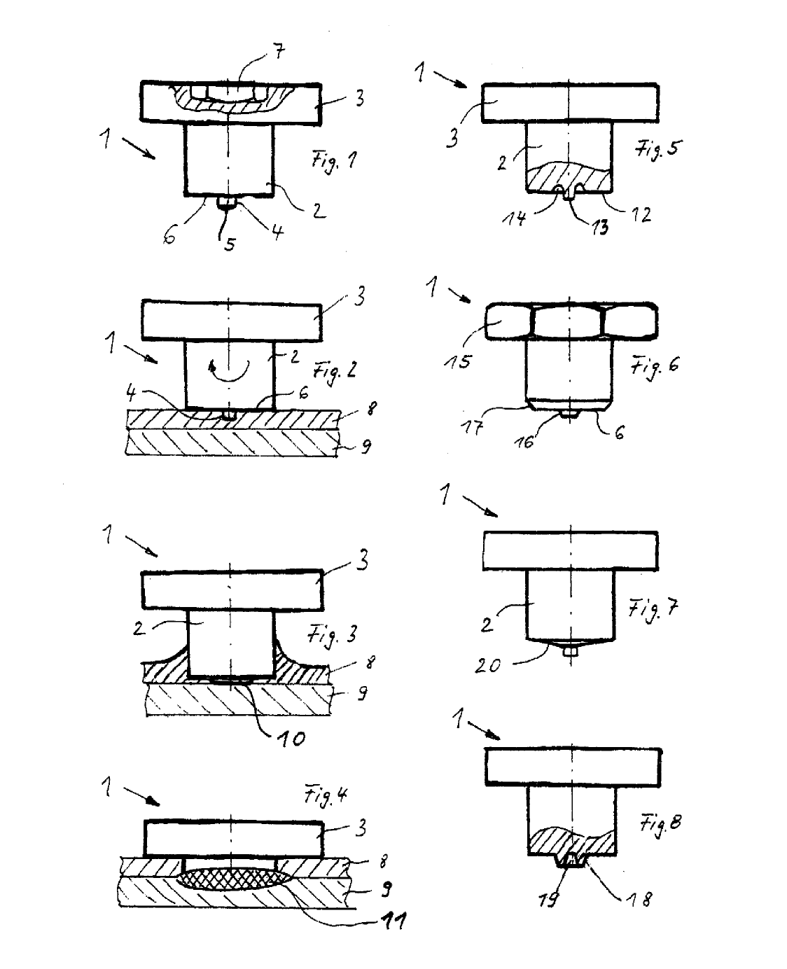

FIG. 1 shows the connecting element on its own with a short cylindrical pin protruding from the mandrel of the connecting element;

FIG. 2 shows the connecting element of FIG. 1 placed on the top one of two plate-like components;

FIG. 3 shows the connecting element once it has penetrated the top component, with the pin largely deformed;

FIG. 4 shows the completed friction-welded connection with the connecting element and two plate-like components;

FIG. 5 shows a connecting element having a recess surrounding the centering part;

FIG. 6 shows the connecting element having a conical pin which constitutes the centering part;

FIG. 7 shows the connecting element whose mandrel has a flat conical cross-sectional surface;

FIG. 8 shows the connecting element having a pin with a central recess.

FIG. 1 shows the connecting element 1 which consists of the mandrel 2 and the collar 3 mounted thereon. Protruding from said mandrel 2, on its side facing away from the collar 3, is the pin 4 which constitutes the centering part and is particularly short and thin compared to said mandrel 2 but substantially cylindrical in shape, For ease of manufacture, the pin 4 has a slightly rounded end face 5 and protrudes cylindrically from the flat cross-sectional surface 6 of said mandrel 2. The collar 3 furthermore includes a tool holder 7 which here takes the form of an internal hexagon and into which a suitable hexagon key may be inserted which is then used for rotating the connecting element 1 for the connecting procedure.

According to one embodiment of the connecting element 1, its mandrel 2 is between 5 mm and 6 mm in length and between 4 mm and 5 mm in diameter. The pin 4 is between 0.5 mm and 1 mm in length and has a diameter of between 1 mm and 2 mm. Depending on the size of the connecting element, its components may of course also be dimensioned differently.

FIG. 2 shows the connecting element 1 of FIG. 1 as well as two plate-like components, that is to say in a first position in which the cross-sectional surface 6 of said connecting element 1 has contacted the top component 8 and the pin 4 has just penetrated the material of the component 8 and may thus exert its centering function with regard thereto. In its first position as shown in FIG. 2, the connecting element 1 rotates, thus initiating a friction-welding process in a known manner. In this state, the cross-sectional surface 6 of said connecting element 1 bears against the top component 8 and causes said component 8 to soften as a result of the frictional heat thus generated. This allows the connecting element 1 to penetrate the component 8 and its pin 4 to ultimately contact the surface of the component 9. During this penetration process, with the mandrel 2 being centered and guided by the pin 4, the material of the pin 4 will soften and ultimately be deformed completely.

In a second position, in which the pin 4 contacts the surface of the component 9, the pin 4 will be deformed and thus have a wider shape 10, as depicted in FIG. 3. As the axial movement progresses, the pin will ultimately be flattened completely, thus allowing the cross-sectional surface 6 to contact the plate 9 and thus form a friction-welded connection. Owing to the small diameter, the short length and the resulting small volume of the pin, the latter will not impair the friction-welding process.

The completed friction-welding process between the connecting element 1 and the bottom component 9 is shown in FIG. 4 where the narrowly hatched section 11 is a friction-welded zone via which the connecting element 1 is firmly connected to the bottom component 9, with the collar 3 of the connecting element 1 pressing the top component 8 firmly onto the bottom component 9.

Shown in FIG. 5 is a variation of the pin design. It is constituted by the connecting element 1 having the collar 3 and the mandrel 2, with the pin 13 protruding from a front cross-sectional surface 12 of said mandrel 2. In this case, the pin 13 is closely surrounded by an annular recess 14 which serves to contain any material removed from the pin 13 as the connecting element 1 is driven into the top component 8 so as to prevent such removed material from interfering with the subsequent friction-welding process between the cross-sectional surface 6 of the mandrel 2 and the respective top component.

FIG. 6 shows another variation of the connecting element 1 in which the collar 15 is depicted as a hexagon head which may thus be gripped by a respective hexagon key. In this case, the pin 16 is only slightly conical. This view shows the edge of the cross-sectional surface 6 as having a tapered portion 17 which improves the discharge of any removed material from the plate 8.

FIG. 7 shows a variation of the connecting element 1 which consists in a flat conical design of the cross-sectional surface 20 of the mandrel 2.

Shown in FIG. 8 is another variation of the connecting element 1 in which the pin 18, part of which is shown in cross-section, includes an internal recess 19. The resulting relatively narrow edge of the pin 18 may contribute to a stronger guidance by the pin 18 and to facilitating penetration into another component. In this embodiment, the diameter of the pin may also be more than 2 mm.

1. Connecting element (1) for a friction-welded connection for connecting at least two plate-like components (8, 9), having a centering part (4) for centering and guiding the connecting element (1) that is rotated and subjected to pressure as a mandrel (2) penetrates the top component(s) (8), with the length of said mandrel (2) being adapted to the thickness of said top component(s) (8), characterized in that said centering part protrudes as a pin (4, 13, 16) from a substantially flat cross-sectional surface (6, 12) of said mandrel (2) transitioning into the friction-welded connection and is formed so short and thin with respect to the length of the mandrel (2) that, after penetrating the top component(s), the material of said centering part will soften and the centering part will thus practically completely transition into the friction-welded connection.

2. Connecting element according to claim 1, wherein said mandrel (2) has a recess (14) which surrounds the centering part (13) and serves to contain any softened material removed from said centering part (13).

3. Connecting element according to claim 1, wherein said pin (4) is cylindrical in shape.

4. Connecting element according to claim 1, wherein said pin (16) is conical in shape.

5. Connecting element of according to claims 1, wherein said pin (18) has a central recess (19).

6. Connecting element according to claim 2, wherein said pin (4) is cylindrical in shape.

7. Connecting element according to claim 2, wherein said pin (16) is conical in shape.

8. Connecting element of according to claim 2, wherein said pin (18) has a central recess (19).

9. Connecting element of according to claim 3, wherein said pin (18) has a central recess (19).

10. Connecting element of according to claim 4, wherein said pin (18) has a central recess (19).
